(19) United States
(12) Patent Application Publication
(10) Pub. No.: US 2009/0129109 A1
(43) Pub. Date: May 21, 2009

(54) Headlight Reflector and a Headlight Including Such a Reflector

(75) Inventor: Daniel Goraguer, Rouen (FR)

Correspondence Address: SUGHRUE MION, PLLC, 2100 PENNSYLVANIA AVENUE, N.W., SUITE 800, WASHINGTON, DC, 20037, US

(73) Assignee: Holophane SA, Les Andelys (FR)

(21) Appl. No.: 11/913,440

(22) PCT Filed: Apr. 28, 2006
(86) PCT No.: PCT/FR06/50401

§ 371 Date: Nov. 2, 2007

(30) Foreign Application Priority Data
May 3, 2005 (FR) 0551162

(51) Int. Cl. B60Q 1/00; F21V 11/00

(52) U.S. Cl. 362/539; 362/518; 362/519; 362/308

(57) ABSTRACT

A headlight reflector (1) comprising: a reflecting wall (10) defining an optical axis (O); a first opening (12) for inserting and positioning a light source (2); a second opening (18) through which the light that has been reflected by the reflecting wall leaves the reflector; and a light mask (14, 15, 16) that blocks the path of a fraction of the light that would otherwise leave via the second opening, the reflector being characterized in that it is made integrally with the light mask.

The present invention relates to a headlight, and more particularly to a reflector that constitutes a portion of the headlight. The reflector is more particularly suitable for use in a motor-vehicle headlight, e.g. for fog lights. The present invention therefore covers an advantageous application in the motor-vehicle field, but it can also be applied to other fields that require a headlight using a reflector.

In the field of motor-vehicle headlights, numerous headlights are already known comprising a reflector, a lens support, and a lens. The lens is held on the optical axis of the headlight that is defined by a reflecting wall or surface of the reflector. By way of example, the lens may be of the aspherical type comprising a plane rear face and a convex front face on the outside. The plane rear face of the lens is often positioned perpendicularly to, and centered on, the optical axis. In addition to its reflecting wall, the reflector defines a first opening for inserting and positioning a light source that can be constituted by a bulb mounted on an appropriate support, for example. In addition, the reflector also includes a larger second opening through which the light that has been reflected by the reflecting wall leaves the reflector and is directed towards the lens. The bulb of the light source is positioned inside the reflector that forms an inside cavity having a portion of its inside wall formed by the reflecting wall. In general, the bulb is placed on the optical axis of the headlight. In some reflectors, a light screen or mask is also provided, disposed between the bulb and the lens. The purpose of the lens is to redirect the beams that have been emitted by the bulb and reflected by the reflector. The purpose of the mask is to mask a fraction of the direct and reflected beams that, after passing through the lens, would dazzle the drivers of vehicles travelling on the opposite lane. In continental western Europe, this means masking the light beams that are directed upwards and to the left relative to the optical axis. In contrast, the top-right portion can be illuminated without risk of dazzling drivers on the opposite lane. This means having a cut-off line that is lower in the left portion than in the right portion. In general, the mask is constituted by a small plate that is fastened either to the reflector or to the lens support. When the mask is already fastened to the lens support or forms a part thereof, this forces the lens to be fastened to the lens support from the outside, i.e. without penetrating through the lens support. This presents several disadvantages. Firstly, the position of the lens is referenced relative to its rear face which is not really the best mechanical frame of reference for positioning the focus of the lens. Secondly, mounting the lens on the lens support from the outside requires the use of trim that comes into engagement with the lens support and that covers the periphery of the lens. The trim therefore constitutes an additional element. In contrast, when the mask is mounted on the reflector, it is in the form of a plane or curved plate that closes, at least in part, the large opening of the reflector, which opening gives access to the inside cavity in which the bulb of the light source is housed. In general, the mask includes a masking edge that is disposed on the optical axis. In practice, the mask may he constituted by a sheet-metal plate that is fastened to the reflector using any means. When the mask is associated with the tens support, it may be made integrally with the lens support. This does not apply when the mask is disposed or associated with the reflector, given that it closes, at least in part, the inside cavity of the reflector, which would make the cavity impossible to mold and to unmold.

Given that a headlight is constituted by a plurality of elements for assembling in order to constitute the finished headlight, it is clear that efforts are continuously being made to reduce the number of component elements of the headlight in order to reduce the number of assembly operations. In a conventional headlight, it is difficult to achieve fewer than five component elements, namely the reflector, the light source, the mask, the lens support, and the lens.

The object of the present invention is to reduce the number of component elements of a headlight, i.e. to four in number, or even three.

To achieve this object, the present invention provides a headlight reflector comprising: a reflecting wall defining an optical axis; a first opening for inserting and positioning a light source; a second opening through which the light that has been reflected by the reflecting wall leaves the reflector; and a light mask that blocks the path of a fraction of the light that would otherwise leave via the second opening, the reflector being characterized in that it is made integrally with the light mask. The reflector of the invention thus avoids certain investment in tooling, and also avoids an operation of manufacturing and assembling the mask on the reflector or on the lens support. Advantageously, the reflector defines an inside cavity that presents a molding/unmolding axis for molding/unmolding the inside of the reflector, the optical axis intersecting the molding/unmolding axis. It is precisely because the molding/unmolding axis is distinct and intersects the optical axis that it is possible to make the reflector integrally with the mask. In prior-art reflectors, the mask would partially close off the inside cavity formed by the reflector. The optical axis and the molding/unmolding axis of such prior-art reflectors often coincide. By distinguishing and by disassociating the optical axis from the molding/unmolding axis, it is possible to make a reflector inner-cavity having an orientation that makes it possible to form a masking edge or line that is situated on the optical axis of the reflector, and, consequently, of the headlight incorporating the reflector. Assuming that the optical axis is horizontal, and that the bulb is situated to the right and the lens to the left, the molding/unmolding axis extends in upwardly-sloping manner from right to left.

According to an advantageous characteristic of the invention, the first opening extends in such a manner that the light source is positioned off the optical axis. Naturally, that possibility does not exclude the fact that the light source can be positioned on the optical axis, which, conventionally, is generally what happens.

In another aspect of the invention, the first opening extends in a plane that is perpendicular to the optical axis. In a variant, the first opening extends in a plane that is perpendicular to the molding/unmolding axis.

According to a practical characteristic, a major portion of the reflecting wall is situated above the optical axis, and the mask is situated below the optical. axis, the mask defining a masking edge that extends on the optical axis, at least one inside surface of the reflector extending parallel to the molding/unmolding axis. The masking edge can be defined as an inlet edge of the inside cavity formed by the reflector.

In another advantageous aspect of the invention, the second opening defines a plane that is substantially perpendicular to the molding/unmolding axis. Contrary to a conventional headlight reflector having a second opening that extends in a plane that is perpendicular to the optical axis, the second opening then extends substantially perpendicularly to the molding/unmolding axis.

In a practical embodiment, the mask comprises an inner first portion that is situated between the first opening and the masking edge, and an outer second portion that is situated between the masking edge and the second opening, the first portion extending, at least in part, parallel to the molding/unmolding axis, and the second portion being concave at least in part.

The invention also provides a headlight comprising: a reflector as defined above; a light source for being inserted and positioned in the reflector; a lens positioned on the optical axis of the reflector; and a lens support that is suitable for connecting the lens to the reflector. Advantageously, the lens support includes a first edge for co-operating with the lens, and a second edge for co-operating with the second opening of the reflector, the first edge extending in a plane that is perpendicular to the optical axis, and the second edge extending in a plane that is transverse, but not perpendicular to the optical axis. This gives the lens support a substantially-triangular cross-section that results directly from the fact that the optical axis and the molding/unmolding axis intersect. It should also be observed that the molding/unmolding axis intersects the lens support.

The invention is described more fully below with reference to the accompanying drawings which show several embodiments of the invention by way of non-limiting example.

In the figures:

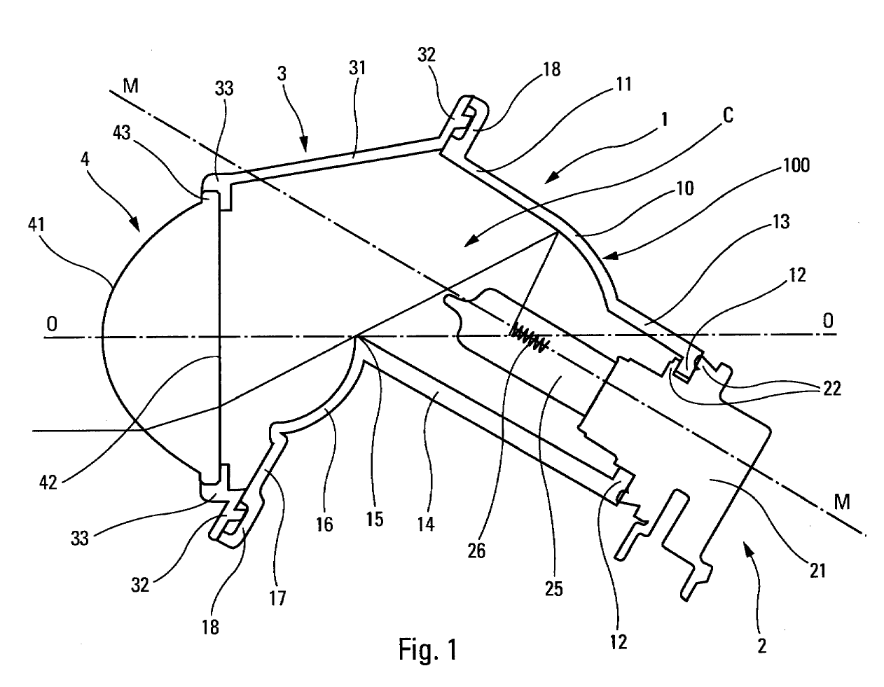

FIG. 1 is a diagrammatic vertical section view through a headlight of the present invention;

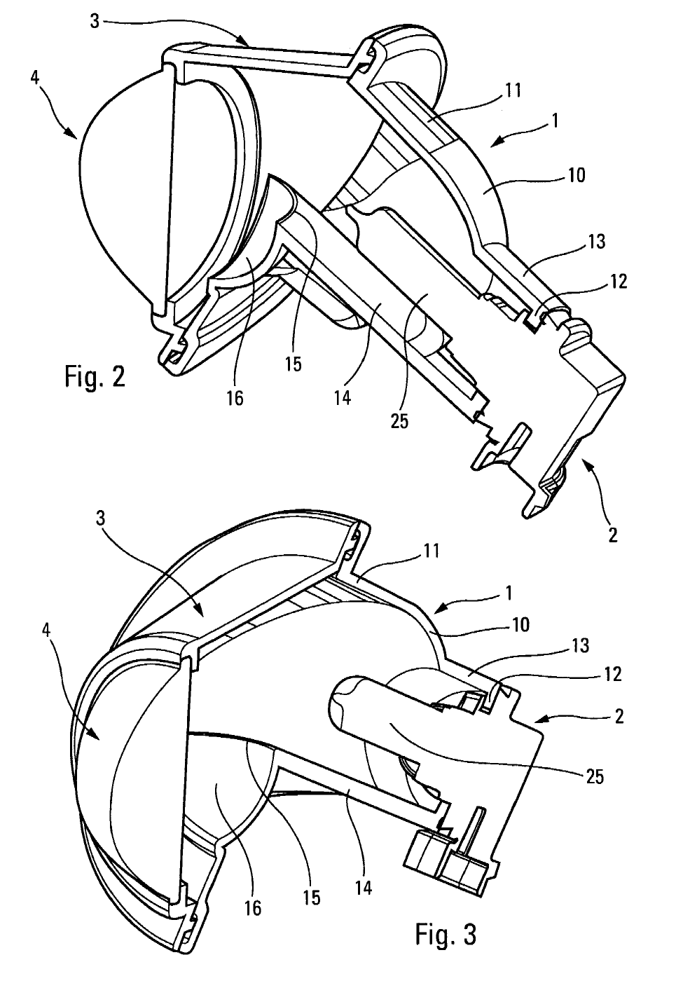

FIG. 2 is a cross-section and perspective view showing the inside of the FIG. 1 headlight;

FIG. 3 is a view similar to the view in FIG. 2 from another view point;

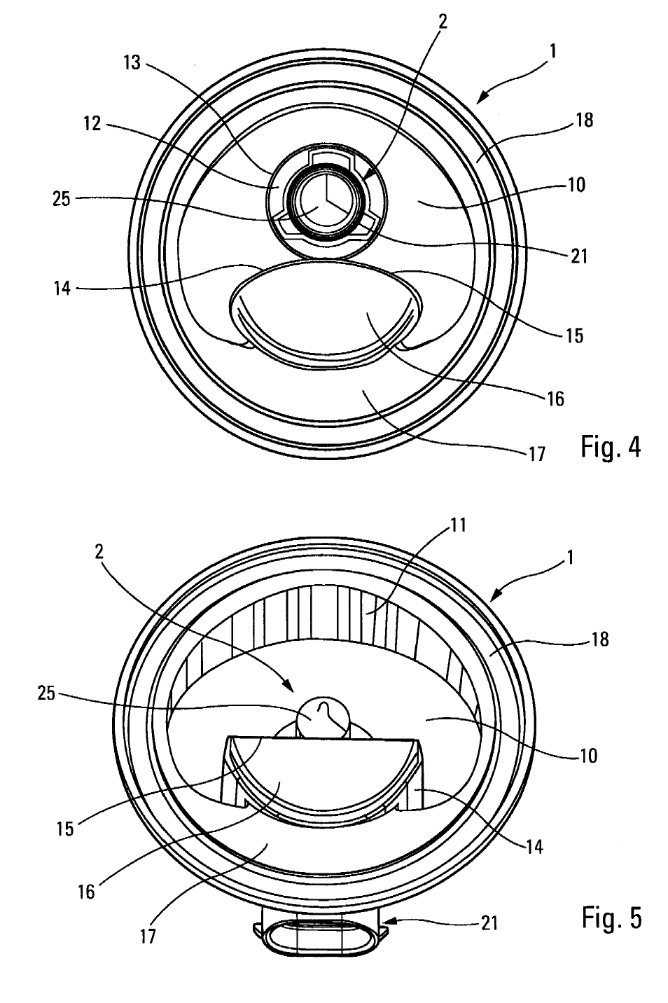

FIG. 4 is a perspective view of the headlight in FIGS. 1 to 3 from a view point that lies on the molding/unmolding axis, with the lens and the lens support removed.

FIG. 5 is a view similar to the view in FIG. 4 from a view point that lies on the optical axis;

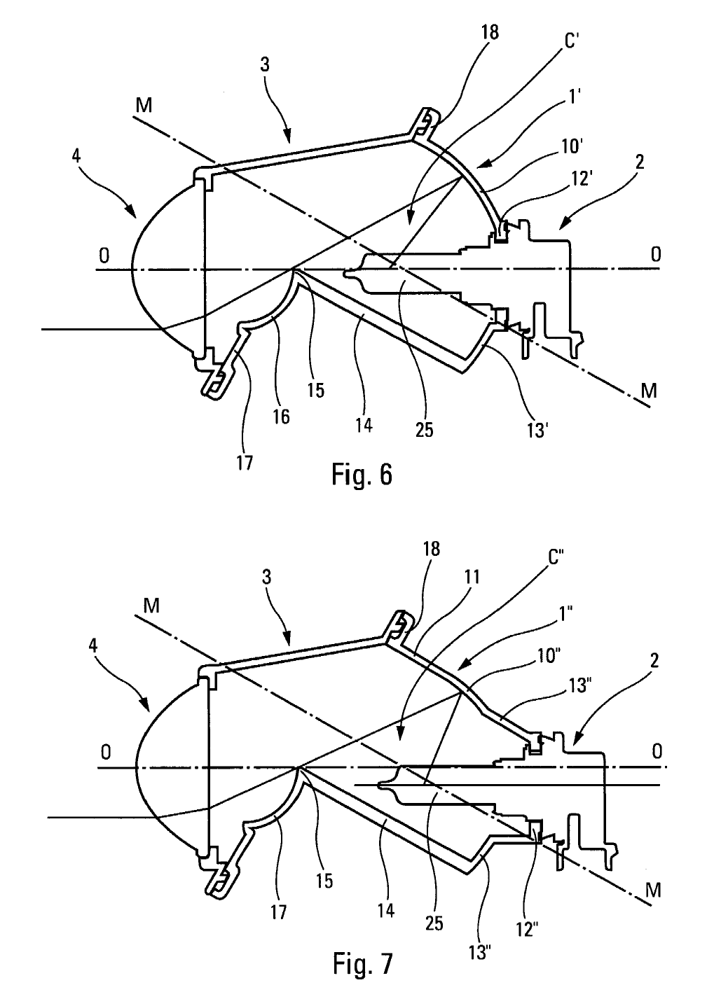

FIG. 6 is a view similar to the view in FIG. 1 showing a second embodiment; and

FIG. 7 is a view similar to the view in FIG. 6 showing a third embodiment of a headlight of the invention.

Reference is made initially to FIGS. 1 to 5 in order to explain the first embodiment of the reflector and of the headlight of the invention. The other two embodiments in FIGS. 6 and 7 are described only by the characteristics that distinguish them from the first embodiment. In all of the embodiments, the headlight comprises four component elements, namely a reflector 1, a light source 2, a lens support 3, and a lens 4.

The reflector 1 is the element that incorporates the major part of the inventive concept of the present invention. The reflector 1 is made as a single part from any appropriate material, such as metal, glass, or a plastics material, for example. The reflector 1 is preferably made by molding. It presents a complex shape that is not circularly symmetrical. The reflector 1 comprises a body 100 that internally defines an inside cavity C. The body 100 defines a first opening 12 that is defined by an inwardly-directed flange. Starting from the inwardly-directed flange 12, the body 100 forms a section 13 of shape that is substantially circularly cylindrical. Beyond the section 13, the body 100 flares so as to form a top reflecting wall that is smooth and a bottom masking piece 14. The reflecting wall 10 extends substantially around the masking piece 14 in the shape of a crescent. This is more visible in FIG. 4. The wall 10 can advantageously be metal plated so as to impart thereto or improve its light-reflecting qualities. A major portion of the masking piece is formed by all axial surface or wall. 14 that is terminated by a Elton wall 16 that can be concave. The axial wall 14 joins the front wall 16 at a masking edge 15. It is the combination formed by the axial wall 14, the masking edge 15, and the front wall 16 that together constitute the mask of the reflector of the invention. With reference once again to FIG. 4, but also to FIG. 5, it can be seen that the mask is formed by the piece that projects towards the inside of the reflecting wall 10. On the side remote from the first opening 12, the inlet of the cavity C can thus be defined, in part, by the masking edge 15. The inlet of the cavity C presents a kidney or crescent shape, as can be seen in FIG. 4. The front wall 16 more or less completes the crescent and is already situated outside the cavity C. Inside the cavity, the reflecting wall 10 is extended outwards, i.e. towards the inlet of the cavity, by a substantially-cylindrical section 11 that extends substantially parallel to the axial wall 14 of the mask. The reflector also defines a second opening 18 that is also in the form of an advantageously-annular circular flange that borders part of the inlet of the cavity C. Furthermore, the second opening 18 extends below the front wall 16 and is connected thereto by a crescent-shaped flat 17. It can be said that the kidney-shaped inlet of the cavity C is inscribed in the second opening 18 that adds the front wall 16 and the flat 17 to the inlet of the cavity C. All or part of the inside surface of the cavity C is advantageously metal plated.

FIGS. 1 to 5 show a very particular embodiment and design of the reflector of the invention. Under no circumstances should it be considered that all of the shapes and features of the reflector are imposed or obligatory for the present invention. The shape of the masking piece can be very different: it suffices that the masking edge 15 is disposed on the optical axis of the reflector, as defined below.

In order to understand the features of the reflector of the invention, it is easier to explain them with reference to the light source 2. The light source 2 comprises a lamp support 21 to which there is associated a lamp or bulb 25. The lamp support 21 includes fastener means 22 for fastening on the flange of the first opening 12. Preferably, the fastener means are leaktight fastener means with a bayonet system. The bulb 25 that is mounted on the support 21 includes a filament 26. The orientation of the bulb 25 is naturally imposed by the support 21 that is engaged in the first opening 12. Consequently, it is the orientation of the first opening 12 that imposes the orientation of the bulb 25 and of its filament 26. Furthermore, precise positioning of the bulb 25 inside the cavity C of the reflector 1 is also imposed by the support 21 and by the first opening 12. As in any conventional reflector, positioning the bulb 25 in the reflector 1 is essential. The filament 26 of the bulb 25 is preferably positioned in the proximity of, or on, the optical axis O of the reflector that is determined by the reflecting wall 10. In FIG. 1, the reflector 1 has been oriented such that the optical axis O extends horizontally in the figure and passes through the lens 4 perpendicularly to its rear face. The reflecting surface 10 extends all around the bulb 25, as can be seen in FIGS. 4 and 5. In addition, FIG. 5 is a view as seen looking along the optical axis O. It is thus possible to see that the filament 26 of the bulb 25 is situated on the optical axis O, as is the masking edge 15. Looking along the optical axis O, the masking edge 15 forms a straight line. It should also be observed that the substantially cylindrical section 11 also presents a crescent shape and extends in the top portion only of the reflector.

It should also be observed that the first opening 12 extends in a plane that is perpendicular to a longitudinal axis of the inside cavity C. The longitudinal axis is the molding/unmolding axis M of the inside cavity C of the reflector. It should also be observed that the support 21 and the bulb 25 also extend along the axis M, or along an axis that is parallel to said axis M.

The axis M advantageously intersects the optical axis O substantially at the filament of the bulb 25. It should also be observed that both the axial wall 14 of the masking piece and the wall 11 extend substantially parallel to the molding/unmolding axis M. This is explained very simply by the fact that the cavity C is formed by a mold core that is then removed from the reflector along the unmolding axis M. The mold core or plug presents a crescent or kidney shape. The end of the plug forms the first opening, and the side walls of the plug form the section 13, the reflecting wall 10, the axial wall 14, and the section 11. Both the axial wall 14 and the section 11 advantageously extend parallel to the molding/unmolding axis M. However, the orientation of the wall 14 and of the section 11 can be conical about the molding/unmolding axis M so as to make unmolding possible: in this event, it is possible to say that the walls 11 and 14 are substantially parallel to the axis M. The plug also forms the masking edge, the front wall, and the periphery of the second opening.

The distinction between the optical axis O and the molding/unmolding axis M is a very advantageous characteristic of the invention. It is specifically this characteristic that makes it possible to make a one-piece reflector that incorporates a light mask. In this embodiment, the light mask is formed by the axial wall 14, the masking edge 15, and the concave front wall 16.

It should also be observed that the second opening 18 extends in x plane that is substantially perpendicular to the axis M and transverse to the axis O.

Other than this particular reflector, the headlight of the invention also includes a particular lens support 3 that differs very clearly from prior-art lens supports that present an overall shape that is a frustoconical cup. In this embodiment, the lens support 3 includes a first edge 33 in engagement with the lens 4, and a second edge 32 in engagement with the second opening 18. The edges 32 and 33 are interconnected by a wall 31 of triangular-shaped cross-section. More precisely, the wall 31 is reduced to nothing at the bottom portion where the edges 32 and 33 touch directly, whereas said wall 31 is at a maximum in its top portion, as can be seen in FIG. 1. The wall 31 can be perforated locally. The first edge 33 extends in a plane that is substantially perpendicular to the optical axis O, whereas the second edge 32 extends in a plane that is substantially perpendicular to the molding/unmolding axis M.

The lens 4 is held in conventional manner, accurately centered on the optical axis O. Its plane rear face 42 faces towards the reflector 1. The lens 4 also includes a collar 43 that is held on the first edge 33. The collar 43 can be fastened using any technique, and preferably using a technique of overmolding the lens support 3 on the lens 4. It is also possible to fasten the lens 4 from inside the lens support 3.

Given that the bulb filament 26, the edge 15, and the center of the lens must be in alignment, the orientation of the cavity C is such that its molding/unmolding longitudinal axis M extends from bottom right to top left, intersecting the lens support 3.

Although in the first embodiment the bulb support 21 and the bulb 25 are held in the first opening 12 on an orientation that is substantially parallel to the molding/unmolding axis M, it is also possible to dispose the support 21 and the bulb 25 on an axis that is parallel to the optical axis O, as can be seen in FIGS. 6 and 7. In both of these embodiments, the first opening 12′ , 12″ extends in as plane that is perpendicular to the optical axis O, but not to the axis M. This makes it possible to dispose the bulb 25 on the optical axis O in FIG. 6, or downwardly offset relative to the optical axis O in FIG. 7. To make this orientation of the first opening possible, the reflector 1 is modified compared to the FIG. 1 design. More precisely, in FIG. 6, the reflecting wall 10′ extends from the first opening 12′ to the second opening 18. In addition, the reflector forms a connection section 13′ between the first opening 12′ and the axial wall 14 of the masking piece.

In FIG. 7, since the axis of the bulb is situated below the optical axis, the first opening 12″ is connected to the reflecting wall 10″ via a section 13″. In addition, below the bulb, the opening 12″ is connected to the axial wall of the masking piece via a connection section that is an angled bend.

In all of the embodiments, the molding/unmolding axis M intersects the optical axis O substantially at the bulb 25, and even more advantageously at the filament 26 of the bulb. It should be observed that this characteristic can be implemented independently of the fact that the light mask is incorporated integrally with the reflector. In some circumstances, it could turn out to be advantageous to disassociate the optical axis from the molding/unmolding axis, but without the reflector incorporating a mask. Disassociating the two axes can therefore be considered as an inventive characteristic in itself.

1. A headlight reflector (1) comprising:
a reflecting wall (10) defining an optical axis (O);
a first opening (12; 12′; 12″) for inserting and positioning a light source (2);
a second opening (18) through which the light that has been reflected by the reflecting wall leaves the reflector; and
a light mask (14, 15, 16) that blocks the path of a fraction of the light that would otherwise leave via the second opening, the mask being made integrally with the reflector;
the reflector being characterized in that it defines an inside cavity (C; C′; C″) that presents a molding/unmolding axis (M) for molding/unmolding the inside of the reflector, the optical axis (O)intersecting the molding/unmolding axis (M).

2. A headlight reflector according to claim 1, in which the first opening (12″) extends in such a manner that the light source (2) is positioned off the optical axis (O).

3. A headlight reflector according to claim 1, in which the first opening (12′; 12″) extends in a plane that is perpendicular to the optical axis (O).

4. A headlight reflector according to claim 1, in which the first opening (12) extends in a plane that is perpendicular to the molding/unmolding axis (M).

5. A headlight reflector according to claim 1, in which a major portion of the reflecting wall (10) is situated above the optical axis, and the mask is situated below the optical axis, the mask defining a masking edge (15) that extends on the optical axis, at least one inside surface (11, 14) of the reflector extending substantially parallel to the molding/unmolding axis (M).

6. A headlight reflector according to claim 1, in which the second opening (18) defines a plane that is substantially perpendicular to the molding/unmolding axis (M).

7. A headlight reflector according to claim 5, in which the mask comprises an inner first portion (14) that is situated between the first opening and the masking edge (15), and an outer second portion (16, 17) that is situated between the masking edge (15) and the second opening (18), the first portion extending, at least in part, substantially parallel to the molding/unmolding axis (M).

8. A headlight comprising:
a reflector according to claim 1;
a light source (2) for being inserted and positioned in the reflector;
a lens (4) positioned on the optical axis of the reflector; and
a lens support (3) that is suitable for connecting the lens to the reflector.

9. A headlight according to claim 8, in which the lens support (3) includes a first edge (33) for co-operating with the lens (4), and a second edge (32) for co-operating with the second opening (18) of the reflector (1), the first edge (33) extending in a plane that is perpendicular to the optical axis (O), and the second edge (32) extending in a plane that is transverse, but not perpendicular to the optical axis.

10. A headlight according to claim 8, in which the molding/unmolding axis (M) intersects the lens support (3).
